(19) United States
(12) Patent Application Publication
(10) Pub. No.: US 2013/0226722 A1
(43) Pub. Date: Aug. 29, 2013

(54) SWITCHABLE ACCESS DEVICE AND METHODS

(71) Applicants: Fucundo Barrera, Miami, FL (US); Diego Rodriguez, Palmetto Bay, FL (US)

(72) Inventors: Fucundo Barrera, Miami, FL (US); Diego Rodriguez, Palmetto Bay, FL (US)

(21) Appl. No.: 13/862,940

(22) Filed: Apr. 15, 2013

Related U.S. Application Data
(63) Continuation of application No. PCT/US2011/055044, filed on Oct. 6, 2011.
(60) Provisional application No. 61/393,882, filed on Oct. 16, 2010.

(51) Int. Cl. G06Q 20/20

(52) U.S. Cl. CPC G06Q 20/202
USPC 705/21

(57) ABSTRACT

A switchable POS device that can be used to process transactions for multiple merchants. The POS device can be temporarily reconfigured to process transactions for a merchant different from the merchant with whom the POS device is linked. After processing the transaction, the POS device reverts back to processing transactions for its linked merchant.

### CROSS-REFERENCES TO RELATED APPLICATIONS

The present application claims benefit under 35 U.S.C. §119(e) of U.S. Provisional Patent Application No. 61/393,882, entitled “Switchable POS Device”, filed Oct. 16, 2010, the content of which is hereby incorporated by reference in its entirety for all purposes.

### BACKGROUND

Currently most of the business-to-business (B2B) payment transactions occur via checks or cash in developing countries. There are several challenges in conducting transactions using checks or cash. For example, checks are vulnerable to fraud, theft, and can be easily damaged during transit from one location to another. Cash is more risky since additional security needs to be provided to transport cash from one location to another. Also cash is subject to theft, counterfeiting, and damage. In addition, it is hard to track cash once it is stolen or lost and often there is no way to recover stolen or lost cash since it is fungible.

Most large suppliers/wholesale distributors of goods often sell their merchandise via small family-owned local retailers, especially in developing countries. The local retailers often do not have sophisticated payment systems that can interact with the suppliers payment systems. Most of the business conducted by the local retailers is in the form of cash, e.g., a consumer pays cash to buy a bottle of Pepsi. Thus, these local retailers often conduct their business with the large suppliers/distributors in cash or using checks. As described above, there are several challenges for using cash and/or checks.

Thus, there is a need for a robust B2B payment system that can alleviate the challenges posed by cash/check transactions.

### SUMMARY

Embodiments of the present invention provide a switchable access device. The access device includes a processor, an input mechanism coupled to the processor, and a memory unit coupled to the processor and the input mechanism. The access device is initially configured to process transactions for a first merchant. The processor is configured to receive an indication, via the input mechanism, to process a transaction for a second merchant. Thereafter the access device receives approval from the first merchant to process the transaction for the second merchant. The processor then receives transaction details of the transaction for the second merchant; and processes the transaction for the second merchant.

In some embodiments, the processor can revert back to processing transactions for the first merchant after processing the transaction for the second merchant. In some embodiments, the transaction for the second merchant comprises the first merchant paying the second merchant for an item purchased from the second merchant. The transactions for the first merchant can include a first transaction wherein a consumer pays the first merchant for an item purchased from the first merchant.

Some embodiments of the present invention provide a method for reconfiguring an access device. The method includes receiving configuration information associated with processing a transaction for a second merchant. The access device is initially configured to process transactions for a first merchant. The method further includes reconfiguring the access device to enable processing of transactions for the second merchant based on the configuration information. Thereafter, the method further includes receiving approval from the first merchant to process the transaction for the second merchant. The method further includes receiving transaction details of the transaction for the second merchant and routing a payment request related to the transaction for the second merchant to an acquirer of the second merchant. Finally the method includes reverting the access device back to processing transactions for the first merchant.

In some embodiments, the transactions for the first merchant can include a first transaction in which a consumer pays the first merchant for an item purchased at the first merchant and the transaction for the second merchant can include the first merchant paying the second merchant for an item purchased from the second merchant. In some embodiments, receiving the indication to process the transaction for the second merchant includes accepting a first card associated with the second merchant and reading instructions stored on the first card to determine an operation specified by the instructions. The first card can include information about a first acquirer associated with the second merchant, information about a first merchant identifier associated with the second merchant, an account identifier associated with the second merchant, and a first authorization code associated with the second merchant. In some embodiments, receiving approval from the first merchant can include receiving a second authorization code associated with the first merchant. The second authorization code may be received from a second card associated with the first merchant.

In some embodiments, processing the transaction associated with the second merchant can include receiving account information associated with a payment device of the first merchant, communicating the account information to a payment processing network, and receiving payment authorization information from the payment processing network. In some embodiments, the method can include reverting back to processing transactions for the first merchant after expiration of a predetermined time period or a specific condition. Certain embodiment of the present invention provide a non-transitory computer-readable medium including instructions which when executed by a processor in an access device, causes the processor to perform the method described above.

Other embodiments of the present invention provide a method for processing a transaction. The method can be performed by an access device, e.g., a POS device. The method includes processing transactions for a first merchant, receiving a request to process a first transaction for a second merchant, receiving an approval from the first merchant, stopping processing of transactions for the first merchant, processing the first transaction for the second merchant, receiving a request to process a second transaction for the first merchant and processing the second transaction for the first merchant. In some embodiments, the second merchant may provide approval before the POS device reverts back to processing transactions for the first merchant.

The method can further include stopping processing of any further transactions for the second merchant prior to processing the second transaction. In some embodiments, the first transaction can be the first merchant paying for an item purchased from the second merchant and the second transaction can be a consumer paying for an item purchased from the first merchant. In some embodiments, receiving an approval from the first merchant can include receiving a first authorization code associated with the first merchant and receiving an approval from the second merchant can include receiving a second authorization code associated with the second merchant.

### BRIEF DESCRIPTION OF THE DRAWINGS

FIG. 1 is a schematic showing a payment processing operation.

FIG. 2 is a functional block diagram of an access device according to an embodiment of the present invention.

FIG. 3 is a schematic illustrating a reconfiguration operation for a POS device according to an embodiment of the present invention.

FIG. 4 is a schematic illustrating a configuration device that can be used to effect the reconfiguration of a POS device according to an embodiment of the present invention.

FIG. 5 is a flow diagram of a process for reconfiguring a POS device according to an embodiment of the present invention.

FIG. 6 is flow diagram of a process for reconfiguring a POS device according to another embodiment of the present invention.

FIG. 7 is block diagram of a computer system.

### DETAILED DESCRIPTION

Embodiments of the present invention generally relate to processing payment transactions and more specifically to methods for processing payment transactions for multiple merchants using the same point of sale device.

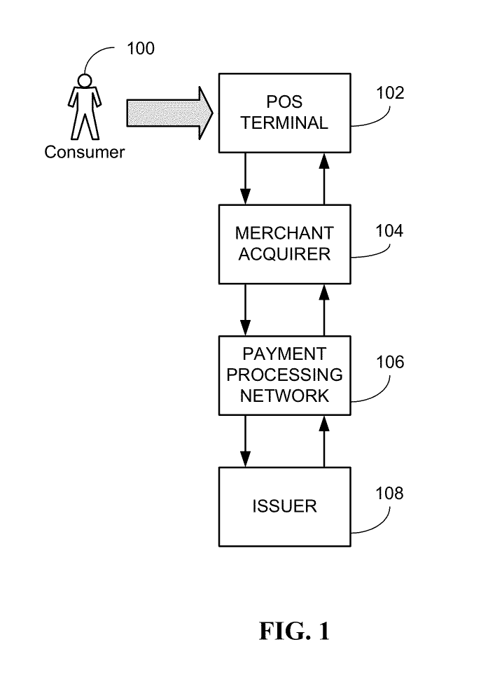

In order to provide a better understanding of the present disclosure, a brief review of transaction processing as it exists today is provided with reference to FIG. 1. For ease of discussion, a transaction conducted in a physical store is described, however it should be understood that similar steps occur in any type of transaction, including online transactions. In a typical transaction, a consumer 100 may select goods or services to purchase at a merchant. The consumer will then pay for the goods or services by presenting a payment device, such as a debit or credit card, or a mobile device, to the merchant. The merchant may then swipe the payment device through a Point of Sale (“POS”) terminal 102 to read the account number from the payment device.

POS terminal 102 may then send the account number to a merchant system (not shown), where other information related to the transaction, such as purchase amount, may be added. It should be noted that in some cases, POS terminal 102 and the merchant system are a single device, in which the account number is read, and the purchase amount is keyed in by the merchant. The transaction details, such as the account number and purchase amount are then sent from the merchant system to an merchant acquirer system 104 to request transaction authorization. An acquirer is generally a bank that holds an account for the merchant in which funds resulting from the transaction will eventually be deposited.

Acquirer system 104 then receives the transaction details, and determines a payment processing network 106 that will process the transaction. Acquirer 104 routes the transaction to the appropriate payment processing network 106, which in turns determines an issuer 108 of the payment device. As mentioned above, an issuer may provide the consumer with an account that holds cash or a line of credit. Payment processing network 106 then routes the transaction to the correct issuer 108 for a transaction authorization decision. If the consumer has sufficient funds in the account or sufficient available credit, issuer 108 will authorize the transaction. The authorization response is transmitted back to the merchant, through payment processing network 106, merchant acquirer 104, and the merchant system. Consumer 100 has then completed the purchase of the goods or services. At a later point in time, a settling and clearing process may occur, in which the funds are actually transferred from the consumer's account (or drawn on the line of credit) to the merchant's account at merchant acquirer 104. The settlement and clearing process occurs using the account number, wherein a request for funds may be compared to a previous authorization, and if an authorization exists, the funds are transferred.

Transactions may become even more complicated when a Personal Identification Number (“PIN”) is required. For example, in the case of some debit card transactions, a PIN must be entered by the consumer. The PIN is typically entered into the POS terminal in clear form by the consumer. The PIN is then encrypted using a Pin Encryption Key (PEK) in the POS terminal and is sent to a merchant system, which also knows the PEK. The merchant system, then decrypts the PIN using the PEK, and encrypts it again using an acquirer working key (AWK), which is a key known by the merchant and the acquirer. The acquirer then decrypts the PIN using the AWK and encrypts again using a payment processor key. The payment processor in turn decrypts the PIN and encrypts using an issuer working key. The issuer then decrypts the PIN and determines if the PIN is correct.

As described above, system 100 includes a POS terminal 102. POS terminal 102 may also be referred to simply as a terminal and may include a processor and a memory coupled to the processor. The memory may comprise computer instructions, which when executed by the processor cause the processor to execute the functions that are described below. In addition, the memory may also contain one or more keys, such as encryption keys. The key may allow the POS terminal 102 to encrypt data such that it can only be decrypted by an entity that possesses a corresponding key. For example, the key may be part of a symmetric or asymmetric key pair. The corresponding key may be stored in a key database of payment processing network 106. Thus, data encrypted by the POS terminal 102 may only be decrypted by payment processing network 106.

The transaction data received at POS terminal 102 can be encrypted using any number of encryption standards (e.g. DES, TDES with bundled keys, AES-128, AES-256, etc.). Furthermore, encryption/decryption can be performed by POS terminal 102 using a symmetric or non-symmetric key. In one embodiment, the non-symmetric key is a public key with an optional private key. Additionally, any number of encryption algorithms can be used (e.g. RSA, ECC, etc.). In one embodiment, an encryption control signal (ECS) can be used to accommodate key signature sizes. It should be understood that any form of encryption that ensures that data encrypted by a first element can only be decrypted by a second element using associated keys would be suitable in embodiments of the disclosure.

The encryption key stored in POS terminal 102 may be unique to that terminal. Each POS terminal 102 may have an identifier associated with it, and a specific key associated with that terminal identifier. Thus, when data encrypted by POS terminal 102 is received by payment processing network 106, payment processing network 106 utilizes the terminal identifier to determine the key associated with that particular POS terminal. The correct key can then be retrieved form the key database and the encrypted data can be decrypted.

As can be seen from the description above, conventionally, a POS terminal is associated with a single merchant. The POS terminal is programmed to process transactions for that merchant only. Thus, all payment transactions conducted using the POS terminal are routed to an acquirer associated with that merchant. Also, a POS terminal associated with the merchant is usually located at the merchant's place of business.

Certain embodiments of the present invention allow temporarily reconfiguring a POS terminal to process transactions for a merchant that is different from the merchant with which the POS terminal is associated. For example, consider that a POS terminal is associated with merchant A, e.g., Macys®. Embodiments of the invention disclosed herein can allow the POS terminal to also process transactions for merchant B, e.g., Wal-Mart® temporarily by reconfiguring the POS terminal. In some embodiments, merchant A may be a national or regional chain of stores/restaurants, e.g., Safeway, and merchant B can be a wholesaler of goods/services, e.g., Tyson Foods, Inc.

Several advantages can be realized by such a switchable POS device. First, this would greatly simplify the transactions between a wholesale dealer and a retail merchant that buys products from the wholesale dealer and sells them to consumers. For example, when a wholesale dealer ships a product to the retail merchant, the wholesale dealer personnel delivering the product can temporarily “switch” the retail merchant's POS device to process transactions for the wholesale dealer using a configuration device. The retail merchant can then use the POS device to pay the wholesale merchant on the spot without needing any of the risky methods of payments like check or cash. The POS device can then be switched back either manually or automatically to resume processing payments for the retail merchant. Second, several merchants can share a single POS device to process their transactions reducing the overall infrastructure and operation costs for the merchants. Finally, such a POS device provides a very secure way of conducting payment transactions especially in countries where fraud with checks is rampant and cash transactions are prone to theft and counterfeiting.

Some embodiments of the present invention provide a POS access device that is configured to process payment transactions for merchant A but can be reconfigured to process transactions for a different merchant. In other words, the POS device can accept payment from consumers who buy products/services from merchant A as a default. The POS device can be reconfigured to process a payment transaction for a merchant B (who may be a supplier to merchant A), e.g., by using a specially programmed configuration card to reconfigure the POS device. Thereafter, the POS device can process the next payment transaction for merchant B instead of merchant A. After processing the payment transaction for merchant B, the POS device may resume processing payment transactions for merchant A again.

In a conventional POS device, the information of the acquirer (i.e. financial institution) associated with a first merchant, to whom the POS device belongs, is programmed during the initial setup of the POS device at the first merchant location. The POS device can then only process transactions for that first merchant as long as the first merchant owns the POS device. In this context, processing a transaction means that the POS device sends transaction details associated with a transaction to the acquirer associated with the first merchant. If the POS device is later sold to a second merchant, the POS device can be re-programmed to process transactions for the second merchant, however, after the reprogramming, the POS device can no longer process transactions for the first merchant. Currently, there is no mechanism to temporarily re-configure a POS device to process a transaction for a merchant different than the merchant with whom the POS device is currently associated.

It is to be noted that the following description of various embodiments of the present inventions is provide using a POS device as an example. One skilled in the art will realize that there are several types of devices that can fall in the general category for a POS device. These device may include but are not limited to POS terminals, cash registers, contactless terminals such as NFC terminals, etc. In sum, any device that is capable of performing the functions the POS device detailed herein can be generally called a POS device regardless of its structure or any specific name by which it is known.

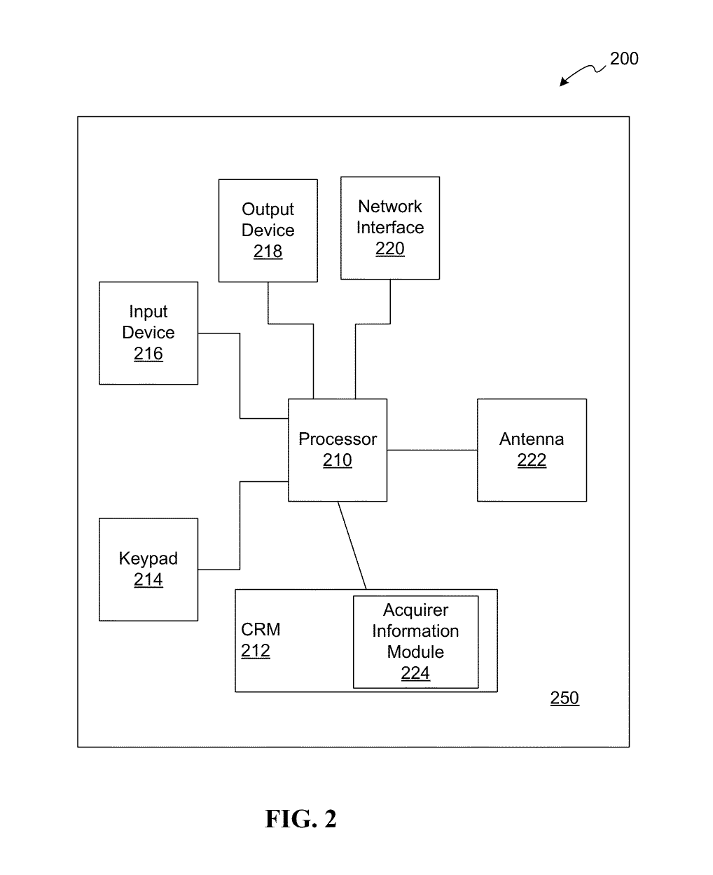

FIG. 2 is a functional block diagram of an access device (e.g., a POS device) 200 according to an embodiment of the present invention. Access device 200 may include a processor 210. Access device 200 may also include a non-transitory computer-readable storage medium (CRM) 212, a keypad 214, an input device 216, an output device 218, a network interface 220, an antenna 222, and an acquirer information module 224. All of these elements may be operatively coupled to processor 210. A housing 250 may house one or more of these components.

Input device 216 can be in any suitable form, such as a magnetic stripe reader to read data from standard cards, a contactless reader to energize and read data from contactless cards, or a contact reader to energize and read data from a smartcard. Input device 216 can be in any suitable form to read account identification information from any suitable payment device.

CRM 212 may include one or more memory chips, disk drives, etc. CRM 212 may store code or instructions for allowing merchant access device 200 to operate in the manner described herein. The instructions may be executed by processor 210.

CRM 212, or memory, may further comprise any suitable code. The code may be suitable to cause merchant access device 200 to perform any or all of the functionality of merchant access device 200 as described herein. In some embodiments, CRM 212, or memory, comprises: a) code for receiving information from a merchant; b) code for sending information to the merchant; c) code for receiving information from a payment device; d) code for sending information to the payment device; e) code for receiving information from a consumer; f) code for sending information to the consumer; g) code for sending information to server computer of an acquirer; h) code for sending information to a server computer of the payment processing network; i) code for sending information to a server computer of issuer; j) code for receiving information from server computer of the acquirer; k) code for receiving information from the server computer of the payment processing network; and/or l) code for receiving information from the server computer of the issuer.

Keypad 214 may be operable to input information such as transaction information into merchant access device 200. In some embodiments, input device 216 may be operable to read information from a magnetic strip of a card such as a credit card or a debit card. Output device 218 may include a display. The display may display, for example, transaction information. Network interface 220 may be operable to enable merchant access device 200 to communicate with other system entities. For example, it may enable merchant access device 200 to communicate with one or more of a merchant acquirer, a payment processing network, and/or a issuer. Antenna 222 may be provided to enable merchant access device 200 to operate remotely.

Acquirer information module 224 may include information about an acquirer associated with the merchant where access device 200 is located. Information included in acquirer module 224 can inform access device 200 where to route data related to a payment transaction. In some embodiments, when access device 200 is reconfigured, information in acquirer module 224 may be modified temporarily to enable access device 200 to route data related to a payment transaction to a different acquirer.

It will be appreciated that the system configurations and components described herein are illustrative and that variations and modifications are possible. While the access device is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of devices including electronic devices implemented using any combination of circuitry and software.

In one embodiment, access device 200 may be capable of generating a cryptogram each time a payment device is read for added security. In the case of contactless communication with the payment device, input device 216 can be a transceiver capable of short range, or near field communication (NFC), such as an radio frequency RF transceiver, or an optical scanner.

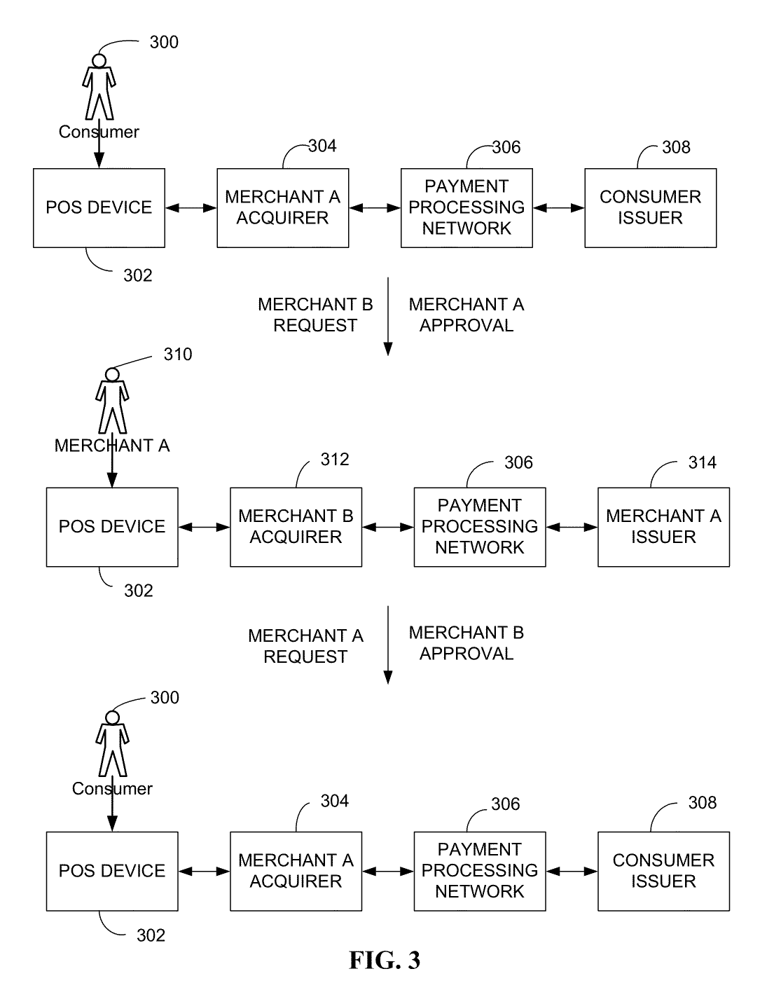

As described above, a same POS device can be used to process transactions for different merchants. FIG. 3 is a schematic that illustrates operation of a switchable POS device according to an embodiment of the present invention.

A POS device 302 is initially configured to process transactions for merchant A. When operating in this mode, POS device 302 routes a payment request for a transaction involving a user 300 to merchant A acquirer 304. In this example, user 300 is a consumer who is visiting merchant A to buy a product/service, e.g., a bottle of water. Merchant A acquirer 304 may forward the payment request to payment processing network 306 which in turn may communicate with an issuer 308 associated with the payment device used by user 300, to process the payment. Next consider that merchant A receives a fresh supply of bottled water from a bottled water wholesale dealer merchant B. When the delivery person of merchant B delivers the bottled water, merchant A may pay merchant B for the new stock of bottled water. Instead of accepting a check or cash, which can be risky as described above, from merchant A, the merchant B delivery person can access POS device 302 and temporarily reconfigure POS device 302 to process payments for merchant B, e.g., by swiping a specially coded card via the input device of POS device 302.

This action by the delivery person of merchant B temporarily reconfigures POS device 302, e.g., it temporarily changes the acquirer information in the acquirer information module described above. In some embodiments, merchant A may provide his approval, e.g., using an access/identification code, to allow the temporary reconfiguration of POS device 302. Once the reconfiguration is completed, merchant A may use his payment device, e.g., a credit or debit card or a mobile communication device such as a cell phone, and present that to POS device 302. However, for this transaction, POS device 302 routes the payment request to merchant B acquirer 312 (not merchant A acquirer 304), which in turn sends the payment request to merchant A issuer 314 via payment processing network 306. Thus, merchant A is able to pay merchant B using the same POS device that merchant A uses to process transactions from his consumers.

In some embodiments, POS device 302 may be configured to automatically revert to its original state of processing payment transactions for merchant A. In other embodiments, merchant A may present his own configuration card to POS device 302 in order to cancel the earlier reconfiguration and return POS device 302 back to its original state. In some embodiments, an approval from the merchant B person may be needed to revert the POS device back to its original configuration.

Several methods can be used to perform the reconfiguration of the POS device. In some embodiments, a special access code may be provided to each merchant. A merchant may use the special access code to temporarily reconfigure the POS device. In other embodiments, a configuration device, similar to a credit card or a key fob, may be used to perform the reconfiguration. One advantage of using a configuration device is that it is more secure and less prone to misuse compared to a mere access code. In some embodiments, the configuration device may include information needed to effect the reconfiguration of the POS device. Needless to say, keeping the information in the configuration device in an encrypted or encoded form will provide higher level of security against tampering and/or theft.

The type of information needed to perform the reconfiguration of the POS device may depend on the type of POS device and the entities involved in a payment processing process. Each country may have a unique flow of how card-based or electronic payments are processed. FIG. 1 merely illustrates one of the payment processing schemes in use. Thus, the type of information needed to perform the reconfiguration may vary and the configuration device may need to be prepared accordingly.

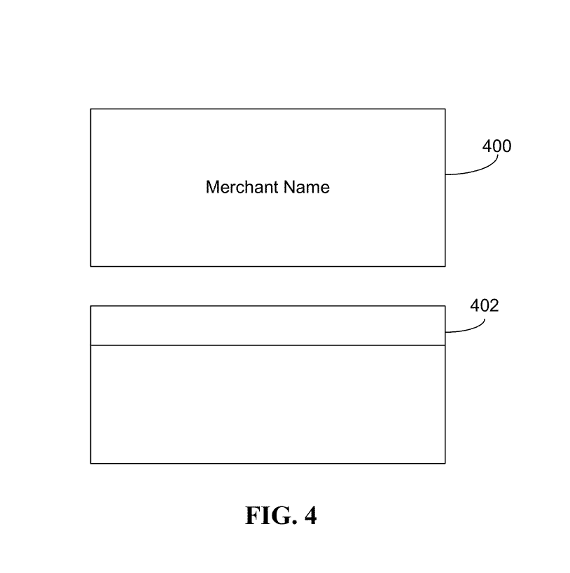

FIG. 4 is a schematic of a configuration device 400 according to an embodiment of the present invention. Although configuration device 400 is shown as being similar to a credit card, this need not be the case. Any other suitable structure like a key fob, a smart card, or near-field communication device may also be used. Configuration device 400 may have name and other identifying information about a merchant disposed on a first side. On a second side, a magnetic stripe 402 may include encoded information to be used for performing the reconfiguration of a POS device. In some embodiments, instead of magnetic stripe 402, configuration device 400 may include an integrated circuit chip similar to a smart card. The integrated circuit chip may include the information to be used for performing the reconfiguration. In still other embodiments, configuration device may include near field communication (NFC) technology, which may include the reconfiguration information. In some embodiments, dynamic passcodes may generated by tokens, display cards, etc. may be sent to mobile device of the merchant A or B person to be used for the authorization. It is to be noted configuration device 400 is exemplary only and should not be construed to limit the structure of the configuration device to what is illustrated in FIG. 4. One skilled in the art will realize that many other types of configuration devices are possible.

Regardless of the type of configuration device used, every configuration device may include information to be used to perform the reconfiguration of the POS device. In some embodiments, the information included in the configuration device may include a unique identifier assigned to the merchant requesting the reconfiguration and an identifier associated with the acquirer of the merchant requesting the reconfiguration. In some embodiments, this information may be provided in an encoded form in magnetic stripe 402 or in an integrated circuit embedded in configuration device 400. In some embodiments, once the merchant B configuration device is presented to the POS device, the reconfiguration can occur without any further input from merchant A or the merchant B personnel. In another embodiment, once the merchant B configuration device is presented to the POS device, the merchant B person may have to input a unique passcode associated with merchant B to enable the reconfiguration to proceed. This may prevent the unauthorized use of merchant B configuration device. In yet another embodiment, once merchant B configuration device is presented to the POS device, merchant A may need to input his own unique passcode in order to authorize the reconfiguration. In still another embodiment, both merchant A and merchant B person may have to enter their respective passcodes once the merchant B configuration device is presented to the POS device in order to authorize the reconfiguration.

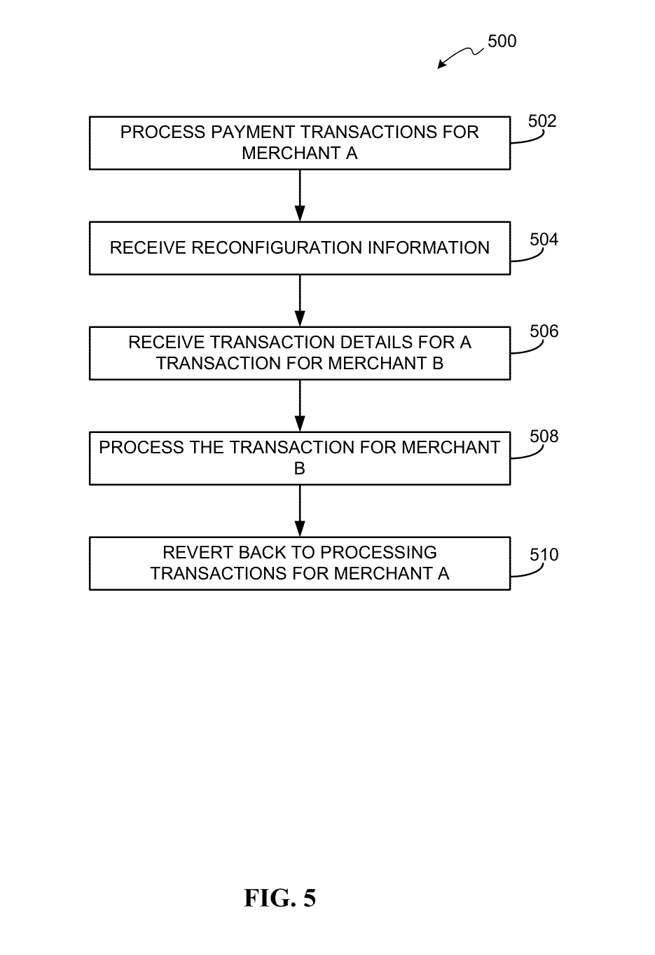

FIG. 5 is a flow diagram of a process 500 for reconfiguring a POS device according to an embodiment of the present invention. Process 500 can be performed, e.g., by POS device 200 of FIG. 2. Initially, the POS device can process payment transactions for merchant A (S502), e.g., POS device is located at merchant A location and is “linked” to merchant A. Thereafter the POS device can receive reconfiguration information (S504). In some embodiments, the reconfiguration information may instruct the POS device to process the subsequent transaction(s) for merchant B. In some embodiments, the request may include presenting a merchant B configuration device to the POS device, which includes the information for reconfiguring the POS device. Based on the received information, the POS device then may reconfigure itself to process transactions for merchant B. Thereafter, the POS device may receive transaction details for a transaction for merchant B (S506). The POS device may process the transaction for merchant B (S508) and then revert back to processing transactions for merchant A (S510).

It should be appreciated that the specific steps illustrated in FIG. 5 provides a particular method of processing transaction for multiple merchants according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. In particular, several steps may be omitted in some embodiments. One of ordinary skill in the art would recognize many variations, modifications, and alternatives.

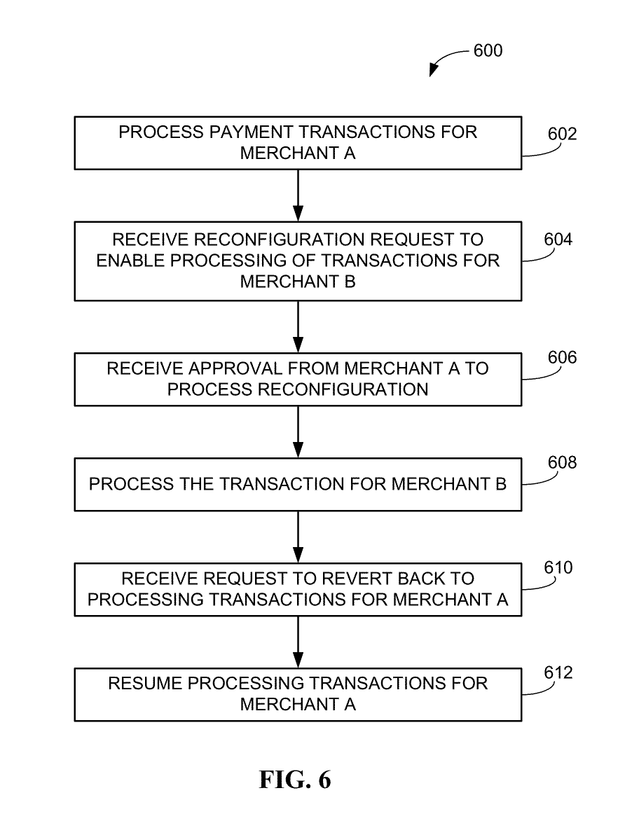

FIG. 6 is a flow diagram of process 600 for reconfiguring a POS device according to another embodiment of the present invention. Process 600 can be performed, e.g., by POS device 200 of FIG. 2.

Initially, the POS is configured to process transactions for merchant A and is linked to the acquirer of merchant A (S602). Thus any payment transaction processed using the POS device is automatically routed to the acquirer of merchant A. At some point, the POS device can receive a reconfiguration request to enable processing of payment transactions for merchant B (S604). For example, the delivery person of merchant B may present his configuration device to the POS device, which reads the information in the configuration device. Thereafter the POS device may request merchant A to approve this reconfiguration request. In response, the POS device may receive an approval from merchant A to perform the reconfiguration (S606), e.g., by merchant A inputting an access/confirmation/identification code into the POS device. This may be done to ensure that the reconfiguration request is genuine and will prevent fraud by not allowing the reconfiguration unless the owner of the POS device (in this instance merchant A) is aware of the reconfiguration and has expressly agreed to the reconfiguration. In some embodiments, the acquirer for merchant A and merchant B can be the same entity.

Once the POS device receives the approval from merchant A, the POS device may reconfigure itself using the information received in S604 and be able to process a transaction for the benefit of merchant B. Thereafter, the POS device can process a payment transaction for merchant B (S608). In this context, processing a transaction for merchant B means at least that the POS device routes the transaction details to the acquirer associated with merchant B. Thereafter the payment processing proceeds per the conventional method described in relation to FIG. 1 above. The POS device may receive another request to revert back to processing transactions for the benefit of merchant A (S610). In some embodiments, this can be done by merchant A by presenting his configuration device to the POS device to effect the reversal. The POS device can then process the request and revert back to processing transactions for merchant A (S612). In some embodiments, an express approval by merchant B may be needed before the POS device can revert back to its original configuration. In other embodiments, the POS device may automatically revert back to its original configuration upon expiration of a pre-determined time, after a pre-determined number of transactions, or a when a set transaction amount is reached, e.g., $1000. This will help to limit the exposure of merchant A to fraud in the instance where the POS device is reconfigured without merchant A's knowledge or authorization.

It should be appreciated that the specific steps illustrated in FIG. 6 provides a particular method of reconfiguring a POS device according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. In particular, several steps may be omitted in some embodiments. One of ordinary skill in the art would recognize many variations, modifications, and alternatives.

In some embodiments, a POS device as described herein can be shared by several merchants. For instance consider that a group of two or more merchants are sharing a common retail space. In this instance, instead of each merchant buying/leasing a separate POS device, the group of merchants can share a single POS device. The POS device may be programmed with information for acquirers associated with each of the merchants. When processing a transaction, a merchant may select the correct acquirer from a list. This will inform the POS that device that the transaction following the selection is to be routed to the selected acquirer. In some embodiments, each of the merchants may be provided a configuration card, e.g., configuration device as described above. A merchant may then use his configuration card to program the POS device to process transactions for the merchant. Another merchant may use his configuration card to do the same. In this manner a single POS device may be shared between a group of merchants. In some embodiments, a merchant from the group of merchants can use the shared POS device to pay another merchant in the group using techniques similar to the one described herein.

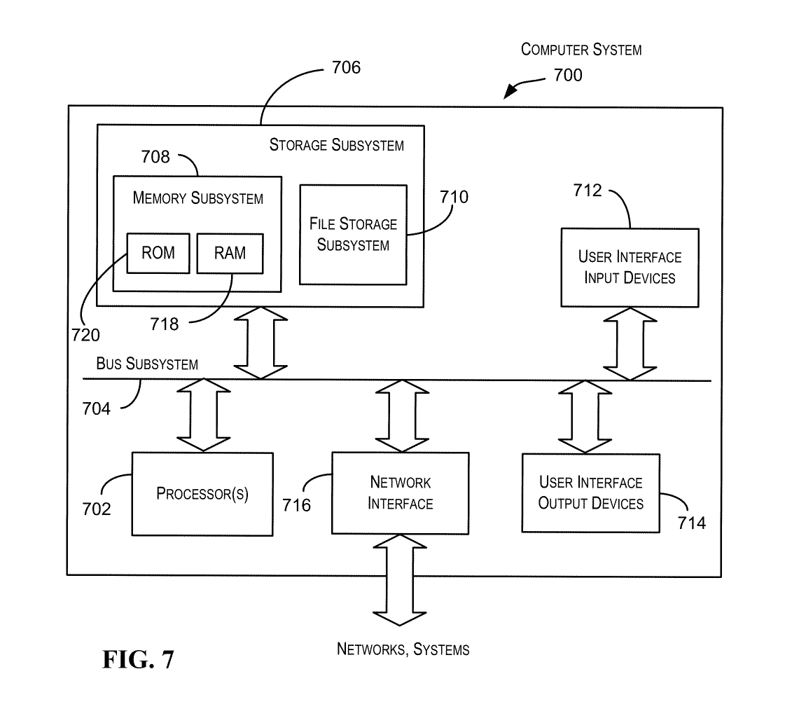

FIG. 7 is a block diagram of a computer system that may be used to implement any of the systems or sub-systems described herein. As shown in FIG. 7, computer system 700 includes a processor 702 that communicates with a number of peripheral subsystems via a bus subsystem 704. These peripheral subsystems may include a storage subsystem 706, comprising a memory subsystem 708 and a file storage subsystem 710, user interface input devices 712, user interface output devices 714, and a network interface subsystem 716.

Bus subsystem 704 provides a mechanism for enabling the various components and subsystems of computer system 700 to communicate with each other as intended. Although bus subsystem 704 is shown schematically as a single bus, alternative embodiments of the bus subsystem may utilize multiple busses.

Network interface subsystem 716 provides an interface to other computer systems and networks. Network interface subsystem 716 serves as an interface for receiving data from and transmitting data to other systems from computer system 700. For example, network interface subsystem 716 may enable a user computer to connect to the Internet and facilitate communications using the Internet.

User interface input devices 712 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 700.

User interface output devices 714 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 706 provides a computer-readable storage medium for storing the basic programming and data constructs that provide the functionality of the present invention. Software (programs, code modules, instructions) that when executed by a processor provide the functionality of the present invention may be stored in storage subsystem 706. These software modules or instructions may be executed by processor(s) 702. Storage subsystem 706 may also provide a repository for storing data used in accordance with the present invention. Storage subsystem 706 may comprise memory subsystem 708 and file/disk storage subsystem 710.

Memory subsystem 708 may include a number of memories including a main random access memory (RAM) 718 for storage of instructions and data during program execution and a read only memory (ROM) 720 in which fixed instructions are stored. File storage subsystem 710 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 700 can be of various types including a personal computer, a portable computer, a workstation, a network computer, a mainframe, a kiosk, a server or any other data processing system. Due to the ever-changing nature of computers and networks, the description of computer system 700 depicted in FIG. 7 is intended only as a specific example for purposes of illustrating the preferred embodiment of the computer system. Many other configurations having more or fewer components than the system depicted in FIG. 7 are possible.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. An access device comprising:
a processor;
an input mechanism coupled to the processor; and
a memory unit coupled to the processor and the input mechanism;
wherein the processor is configured to:
receive an indication, via the input mechanism, to process a transaction for a second merchant, wherein the access device is configured to process transactions for a first merchant;
receive approval from the first merchant to process the transaction for the second merchant;
receive transaction details of the transaction for the second merchant; and
process the transaction for the second merchant.

2. The access device of claim 1 wherein the indication to process the transaction for the second merchant includes configuration information instructing the access device to route the transaction for the second merchant to an acquirer associated with the second merchant.

3. The access device of claim 2 wherein the configuration information comprises a unique identifier associated with the second merchant and an identifier associated with the acquirer of the second merchant.

4. The access device of claim 1 wherein the processor is further configured to revert back to processing transactions for the first merchant after processing the transaction for the second merchant.

5. The access device of claim 1 wherein the transaction for the second merchant comprises the first merchant paying the second merchant for an item purchased from the second merchant.

6. The access device of claim 1 wherein the transactions for a first merchant comprise a first transaction wherein a consumer pays the first merchant for an item purchased from the first merchant.

7. The access device of claim 1 wherein to process the transaction for the second merchant, the processor is further configured to:
send transaction information associated with the transaction for the second merchant to an acquirer associated with the second merchant; and
receive a message indicating successful completion of the transaction for the second merchant.

8. A method comprising:
receiving, by an access device, configuration information associated with processing a transaction for a second merchant, wherein the access device is configured to process transactions for a first merchant;
reconfiguring, by the access device, itself to enable processing of transactions for the second merchant based on the configuration information.
receiving, by the access device, approval from the first merchant to process the transaction for the second merchant;
receiving, by the access device, transaction details of the transaction for the second merchant;
routing, by the access device, a payment request related to the transaction for the second merchant to an acquirer of the second merchant; and
reverting, by the access device, back to processing transactions for the first merchant.

9. The method of claim 8 wherein transactions for the first merchant comprise a first transaction in which a consumer pays the first merchant for an item purchased at the first merchant.

10. The method of claim 8 wherein the transaction for the second merchant comprises the first merchant paying the second merchant for an item purchased from the second merchant.

11. The method of claim 8 wherein receiving the configuration information comprises:
accepting a first configuration device associated with the second merchant, the first configuration device including the configuration information;
reading the first card to determine the configuration information; and
storing the configuration information in a memory of the access device.

12. The method of claim 11 wherein the configuration information comprises:
an acquirer identifier of an acquirer associated with the second merchant; and
a merchant identifier associated with the second merchant.

13. The method of claim 8 wherein receiving approval from the first merchant comprises receiving an authorization code associated with the first merchant.

14. The method of claim 13 wherein the authorization code is received from a second card associated with the first merchant.

15. The method of claim 8 wherein processing the transaction associated with the second merchant comprises:
receiving account information associated with a payment device of the first merchant; and
communicating a payment request associated with the transaction to an acquirer if the second merchant, the payment request including the account information.

16. The method of claim 8 wherein reverting back to processing transactions for the first merchant comprises reverting back after expiration of a predetermined time period.

17. A non-transitory computer-readable medium including instructions which when executed by a processor in an access device, causes the processor to perform the method of claim 8.

18. A method comprising, by an access device:
processing transactions for a first merchant;
receiving a request to process a first transaction for a second merchant;
reconfiguring itself based on the request;
receiving an approval from the first merchant;
stopping processing of transactions for the first merchant;
processing the first transaction for the second merchant;
receiving a request to process a second transaction for the first merchant; and
processing the second transaction for the first merchant.

19. The method of claim 18 further comprising:
prior to processing the second transaction, stopping processing of any further transactions for the second merchant.

20. The method of claim 18 wherein the first transaction comprises the first merchant paying for an item purchased from the second merchant.

21. The method of claim 18 wherein the second transaction comprises a consumer paying for an item purchased from the first merchant.

22. The method of claim 18 wherein receiving an approval from the first merchant comprises receiving a first authorization code associated with the first merchant.
